(19) United States
(12) Patent Application Publication
(10) Pub. No.: US 2021/0076767 A1
(43) Pub. Date: Mar. 18, 2021

(54) AIR INFLATABLE TYPE HOOD FOR RESPIRATION

(71) Applicant: Il Hyung LEE, SEOUL (KR)

(72) Inventor: Il Hyung LEE, SEOUL (KR)

(21) Appl. No.: 16/965,294

(22) PCT Filed: Dec. 18, 2018
(86) PCT No.: PCT/KR2018/016154

§ 371 Date: Jul. 27, 2020

(30) Foreign Application Priority Data
Jan. 25, 2018 (KR) 10-2018-0009406

(51) Int. Cl. A42B 3/04; A42B 3/28; A62B 7/02

(52) U.S. Cl. CPC A42B 3/0486; A62B 7/02; A42B 3/288

(57) ABSTRACT

Embodiments relate to an air inflatable type hood for respiration, which includes: a compressed air cylinder having a first micropore formed therein, and filled with compressed air; and an airbag arranged to be able to transfer fluid with the compressed air cylinder and deployable in a helmet shape so as to be able to receive the wearer's head through an injection of the compressed air in the compressed air cylinder.

### RELATED APPLICATIONS

This application claims priority to and the benefit of PCT Patent Application No. PCT/KR2018/016154, filed on Dec. 18, 2018, which claims priority to Korean Patent Application Serial No. 10-2018-0009406, filed on Jan. 25, 2018, the disclosures of which are incorporated herein by reference in their entirety.

### BACKGROUND

### Field

Embodiments relate generally to an air inflatable type hood for respiration and, more particularly, to an air inflatable type hood for respiration configured to inflate an airbag included in the hood to completely cover the head of a wearer and allow the wearer to perform respiration.

### Description of the Related Art

Generally, in case of fire, a gas mask is widely used to help a person escape the fire by enabling the wearer to perform respiration and protecting the life of the wearer when the wearer is exposed to harmful gas (or smoke).

A conventional gas mask is difficult to carry because of a large volume and weight thereof, and the canister thereof should be replaced periodically, which are problematic. Therefore, those skilled in the art are interested in research on life-saving equipment which can ensure portability and usability thereof and block inhalation of harmful gases.

As a part of this research, a disposable gas mask having a tubular oxygen storage bag (Patent Document 1) is proposed. The disposable gas mask of Patent Document 1, as described above, allows the tubular oxygen storage bag disposed around a neck of a wearer to be inflated through compressed-air of the compressed-air canister, blocks the smoke of the outside from flowing into a hood, and allows the wearer to inhale oxygen through an inhalation hose. The conventional disposable gas mask can ensure visibility of the wearer through only a sight glass of the hood of the gas mask, but it is difficult to secure a predetermined space between the hood and the head of the wearer.

### Documents of Related Art

(Patent Document 1) Korean Patent No. 10-0934969 (Dec. 23, 2009)

Accordingly, embodiments have been made keeping in mind the above problems occurring in the related art, and the various embodiments are intended to propose an air inflatable type hood for respiration, configured to help a wearer to continuously perform respiration and to be inflated with an airbag by air (or oxygen) stored in a compressed-air canister provided on a side of the airbag.

### SUMMARY

According to an embodiment, there is provided an air inflatable type hood for respiration, the hood may include: a compressed-air canister provided with a first micro hole, and filled with compressed-air; and an airbag disposed to perform fluid communication with the compressed-air canister and being inflated into a helmet shape by the compressed-air injected from the compressed-air canister to accommodate a head of a wearer.

According to an embodiment, the airbag may include: on an outer circumferential surface, a first airbag part having a guide hole allowing inflow of the compressed-air; on an inner circumferential surface of the first airbag part, a second airbag part disposed to perform the fluid communication with the first airbag part; an inner space part accommodating the head of the wearer; and an opening disposed at a lower portion of the airbag.

According to an embodiment, a second micro hole may be perforated between the first airbag part and the second airbag part and a third micro hole may be perforated at an inner circumferential surface of the second airbag part.

According to an embodiment, the second micro hole may be disposed close to the opening, and the third micro hole may be disposed at an upper portion of the inner space part.

According to an embodiment, the guide hole may have a sealing part around an inner circumferential surface of the guide hole.

The above and other objects, features and advantages of the various embodiments will be more clearly understood from the following detailed description when taken in conjunction with the accompanying drawings.

All terms or words used in the specification and claims have the same meaning as commonly understood by one of ordinary skill in the art to which inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

According to the above-description of the present invention, due to injection of air, the airbag according to an embodiment is inflated with air into a helmet shape that is open at a lower part, thus providing a hood capable of completely covering the head of a wearer.

By compressed-air that is filled inside the airbag and inflates the airbag and compressed-air that is forcibly guided toward the inner space part, the hood according to an embodiment has an advantage of maintaining an inflated state of the airbag and of facilitating respiration during the time required for evacuation.

In addition, the airbag according to an embodiment is made of a transparent flame-resistance material, so that the airbag can ensure visibility of the wearer and smooth movement in putting on

According to an embodiment, air (or oxygen) stored inside the compressed-air canister is guided into the inner space part of the airbag. Therefore, the airbag can prevent inflow of harmful gas into the inner space part and can protect the head of the wearer by buffering an impact caused by external impact through the inflatable airbag.

### BRIEF DESCRIPTION OF THE DRAWINGS

FIG. 1 is a perspective view schematically showing an air inflatable type hood for respiration, according to an embodiment.

FIG. 2 is a longitudinal sectional view schematically showing the air inflatable type hood for respiration, according to an embodiment.

FIG. 3 is an enlarged view showing a part of the air inflatable type hood for respiration, shown in a circular part of FIG. 2, it shows a connection between a compressed-air canister and a guide hole of an airbag.

FIG. 4 is a schematic view showing a folded form of the air inflatable type hood for respiration according to an embodiment.

### DETAILED DESCRIPTION

The above and other objects, features and other advantages of the various embodiments will be more clearly understood from the following detailed description when taken in conjunction with the accompanying drawings. As for reference numerals associated with parts in the drawings, the same reference numerals will refer to the same or like parts through the drawings. In addition, in the description, details of well-known features and techniques may be omitted to avoid unnecessarily obscuring the various embodiments. It will be understood that, although the terms “first”, “second”, etc. may be used herein to describe various elements, these elements should not be limited by these terms. These terms are only used to distinguish one element from another element. In the accompanying drawings, some elements shown in the drawings are exaggerated, omitted, or schematically illustrated, and the size of each element does not necessarily reflect the actual size.

Herein below, an embodiment will be described in detail with reference to the accompanying drawings.

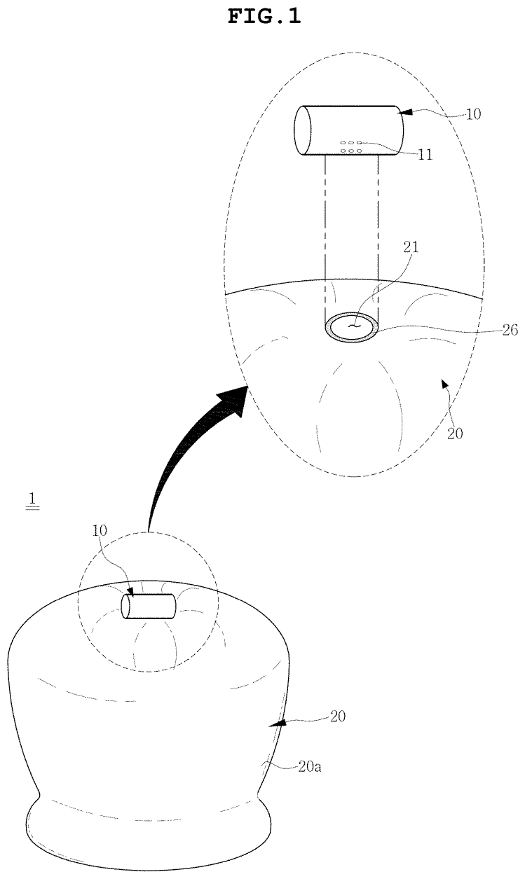

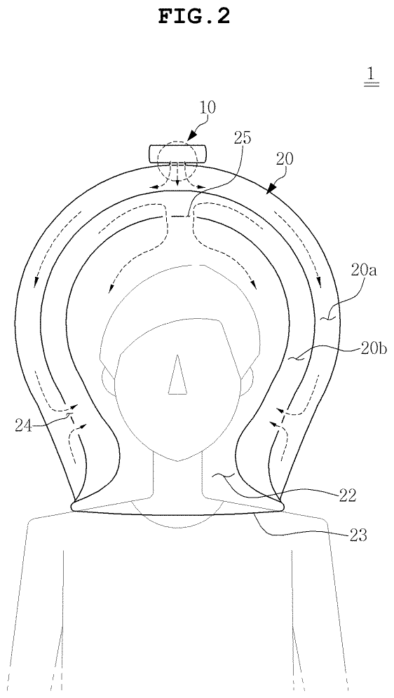

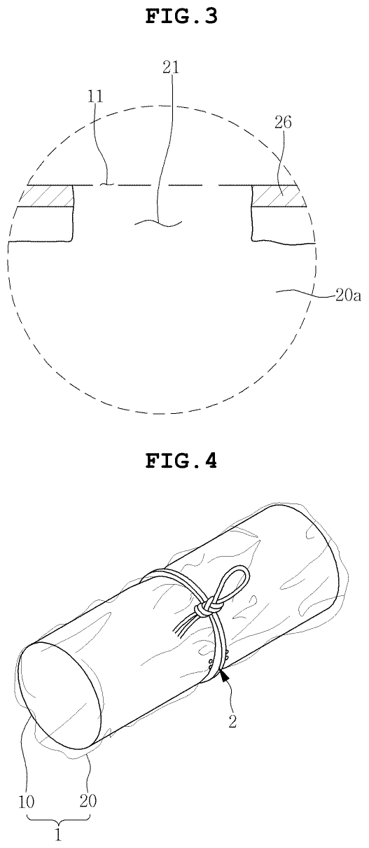

Referring to FIGS. 1 to 3, an air inflatable type hood for respiration 1 according to an embodiment is designed into a dual airbag structure to be wearable on the head of a wearer, that is, to be inflated in size and shape to completely accommodate the wearer's head.

According to an embodiment, the air inflatable type hood for respiration 1 is configured of a compressed-air canister 10 for storing compressed-air, and an airbag 20 coupled to perform the fluid communication with the compressed-air canister 10.

According to an embodiment, the compressed-air canister 10 may have a cylinder shape filled with compressed-air at a higher pressure than atmospheric pressure, and may be disposed removably at an outer circumferential surface of the airbag 20, as shown in the drawings. The compressed-air may include a media, such as oxygen or air that may allow expansion of the airbag 20 and allow the wearer to breath. The compressed-air canister 10 has a first micro hole 11 that guides the compressed-air filled inside the compressed-air canister to the airbag 20. The first micro hole 11 reduces a flow path of the compressed-air as fluid passes in orifice, so that decompression effect due to pressure drop between an inlet of the first micro hole 11 (that is, inside of the compressed-air canister) and an outlet of the first micro hole 11 (that is, outside of the compressed-air canister) can be expected. As mentioned above, the first micro hole 11 may be an outflow path that guides the compressed-air from the compressed-air canister 10 to the airbag 20, and may be used as an inflow path that injects compressed-air into the compressed-air canister 10 as needed.

As shown in the drawings, the airbag 20 may be formed in a shape similar to a helmet with a predetermined size that can accommodate the wearer's head. Otherwise, the airbag 20 may be formed in various shapes such as a hemispherical shape and a conical shape that can cover the head of the wearer. That is, the airbag 20 may be inflate by an injection process of compressed-air discharged from the compressed-air canister 10 and completely cover the head of the wearer. The airbag 20 has a guide hole 21 that is provided on the outer circumferential surface of the airbag to enable the fluid communication with the compressed-air canister 10 and has an opening 23, thus being inflated into a helmet shape that is open at a lower part when air is injected. The wearer's head can be accessed through the opening 23 into an inner space part 22 defined by the airbag 20. The guide hole 21 is perforated on an upper part of the airbag 20, but not limited thereto, and may be perforated on a side part of the airbag.

According to an embodiment, the guide hole 21 may have a sealing part 26 disposed around an inner circumferential surface of the guide hole 21. The guide hole 21 may be disposed to overlap with the first micro hole 11 of the compressed-air canister 10, so that a state between the airbag 20 and the compressed-air canister 10 may be hermetically sealed through the sealing part 26. In addition, the sealing part 26 may be configured as a material capable of fixing a position of the guide hole of the airbag 20 to an outer circumferential surface of the compressed-air canister 10, such as a sealing tape and a sealing adhesive.

In particular, the air inflatable type hood for respiration 1 according to an embodiment is configured as the dual airbag structure having a first airbag part 20a and a second airbag part 20b. As mentioned above, the airbag 20 has the first airbag part 20a formed into the helmet shape and the second airbag part 20b disposed along a circumference of an inner circumferential surface of the first airbag part 20a The first airbag part 20a and the second airbag part 20b are coupled to perform the fluid communication to each other. Therefore, since the first airbag part and the second airbag part are filled with compressed-air, the hood according to an embodiment may have a dual air layer. The airbag 20 has a second micro hole 24 between the first airbag part 20a and the second airbag part 20b, so that the first airbag part 20a and the second airbag part 20b can be connected and perform the fluid communication to each other. Here, the second micro hole 24 may be disposed close to the opening 23 of the airbag 20. In addition, the second airbag part 20b has a third micro hole 25 perforated on an inner circumferential surface of the second airbag part 20b, and can perform the fluid communication with the inner space part 22. Preferably, the third micro hole 25 is disposed on an upper part of the inner space part 22, that is, on the head of the wearer.

The air inflatable type hood for respiration 1 according to an embodiment may be placed on the head of the wearer in the following way, but not limited thereto.

In case of fire, as shown in FIG. 4, when the wearer loosens a knot of a fixing strap 2 attached to the hood 1 rolled-up, the airbag 20 is loosened from the outer circumferential surface of the compressed-air canister 10. Consequently, the hood 1 according to an embodiment may release a contact of the airbag 20 from the first micro hole 11 of the compressed-air canister 10. That is, the first airbag part 20a is inflated through air injected from the compressed-air canister 10 to the first airbag part 20a of the airbag 20, so that the hood according to an embodiment may form the inner space part 22 that can accommodate the head of wearer. As described above, the first airbag part 20a is inflated into the helmet shape while being filled with the compressed-air that passes through the first micro hole 11 and is primarily decompressed. Then, the compressed-air primarily decompressed is injected into the second airbag part 20b through the second micro hole 24 and inflates the second airbag part 20b. In addition, the second airbag part 20b is inflated by the compressed-air that is secondarily decompressed through the second micro hole 24. Since the second micro hole 24 is spaced apart from the first micro hole 11 and is disposed close to the opening 23 as described above, the compressed-air may be guided to the second airbag part 20b that is a back-part installation, after completely inflating the first airbag part 20a In addition, the compressed-air inflates the first airbag part 20a from an upper part while forcibly moving downward from the guide hole 21 to the second micro hole 24, so that the airbag can easily cover around the head of the wearer. Since the second micro hole 24 is disposed close to the opening 23, the second airbag part 20b is inflated from a lower part. As a result of the above-mentioned process, an inner diameter of the opening 23 is reduced. Therefore, it is possible to effectively prevent the harmful gas or smoke of the outside from flowing into the inner space part 22 of the airbag 20. In the hood 1 according to an embodiment, the secondary decompressed compressed-air filled inside second airbag part 20b is forcibly guided through the third micro hole 25 to the inner space part 22. The compressed-air guided to the inner space part 22 may be decompressed enough for the wearer to perform respiration, and be continuously supplied for respiration for a predetermined time required for evacuation (for example, 5 minutes or more). The third micro hole 25 is disposed to be positioned above the head of the wearer as shown in the drawing, and can discharge the decompressed-air (or oxygen) downward to prevent the harmful gas or smoke of the outside from flowing through a gap between a neck of the wearer and the opening 23. In addition, the third micro hole 25 can forcibly push exhalation that occurs during respiration, that is, carbon dioxide that is relatively heavy compared to air, to the opening 23.

Optionally, the air inflatable type hood for respiration 1 according to an embodiment has the airbag 20 made of a transparent flame-resistance material, thereby sufficiently ensuring visibility of the wearer and resisting at a high temperature. The airbag 20 covers the whole of head of the wearer as shown in the drawings, so, in case of fire, the wearer can see the side part, the upper part, the lower part, and the front part with the naked eye. The air inflatable type hood for respiration according to an embodiment can protect the head of the wearer from external impacts by having the air layer through the airbag 20 being inflating by injection of air. Because the inner space part, that is, a space between the face of the wearer and the airbag is filled with fresh oxygen or air, a contact between an inner surface of the airbag and the face can be minimized and dew condensation due to temperature difference can be prevented.

The air inflatable type hood for respiration according to an embodiment is not limited to the dual airbag structure, and may additionally include at least one airbag part on the inner circumferential surface of the second airbag part to perform fluid communication with the second airbag part.

FIG. 4 shows a state of the air inflatable type hood for respiration according to an embodiment, in which the deflated airbag is rolled up around the outer circumferential surface of the compressed-air canister. When the outer circumferential surface of the compressed-air canister 10 is warped by the airbag 20, the first micro hole (11; referring to FIG. 1) is sealed with the airbag thereby blocking inflow of compressed-air from the compressed-air canister to the airbag in advance. Then, the airbag 20 can maintain a rolled state around the circumference of the compressed-air canister 10 by the fixing strap 2 as shown in the drawing. The various embodiments do not require a separated pressure valve (now shown) that charges decompressed compressed-air of the compressed-air canister 10 into the airbag 20, and the various embodiments are configured of a simple structure such that the first micro hole 11 is opened or closed by the airbag 20.

As described above, when the fixing strap 2 comes untied, since compressed-air is injected from the compressed-air canister 10 to the airbag 20 and inflates the airbag 20, the wearer can wear the hood 1 on the head of the wearer.

Hereinabove, although one embodiment has been described for illustrative purposes, the air inflatable type hood for respiration according to various embodiments is not limited thereto, those skilled in the art will appreciate that various modifications, additions and substitutions are possible, without departing from the scope and spirit of the invention as disclosed in the accompanying claims.

All modifications and variations of the various embodiments belong to the scope of the present invention, and the specific protective scope of the various embodiments will be clearly understood by the accompanying claims.

1. An air inflatable type hood for respiration, comprising:
a compressed-air canister provided with a first micro hole, and filled with compressed-air; and
an airbag disposed to perform fluid communication with the compressed-air canister and being inflated into a helmet shape by the compressed-air injected from the compressed-air canister to accommodate a head of a wearer.

2. The air inflatable type hood for respiration of claim 1, wherein the airbag comprises: on an outer circumferential surface, a first airbag part having a guide hole allowing inflow of the compressed-air; on an inner circumferential surface of the first airbag part, a second airbag part disposed to perform the fluid communication with the first airbag part; an inner space part accommodating the head of the wearer; and an opening disposed at a lower portion of the airbag.

3. The air inflatable type hood for respiration of claim 2, wherein, on the airbag, a second micro hole is perforated between the first airbag part and the second airbag part and a third micro hole is perforated at an inner circumferential surface of the second airbag part.

4. The air inflatable type hood for respiration of claim 3, wherein the second micro hole is disposed close to the opening, and the third micro hole is disposed at an upper portion of the inner space part.

5. The air inflatable type hood for respiration of claim 2, wherein the guide hole has a sealing part around an inner circumferential surface of the guide hole.
